(19) United States
(12) Patent Application Publication
(10) Pub. No.: US 2003/0074786 A1
(43) Pub. Date: Apr. 24, 2003

(54) Machine tool and method for working elongated elements, in particular metallic profiled elements

(76) Inventor: Marco Bellucci, Lugano (CH)

Correspondence Address: WILLIAM COLLARD, COLLARD & ROE, P.C., 1077 NORTHERN BOULEVARD, ROSLYN, NY, 11576, US

(21) Appl. No.: 10/169,174

(22) PCT Filed: Dec. 21, 2000
(86) PCT No.: PCT/EP00/13079

(30) Foreign Application Priority Data
Dec. 27, 1999 (CH) 2382/99

(51) Int. Cl. B23Q 15/00

(52) U.S. Cl. 29/711

(57) ABSTRACT

An apparatus and a method for working metallic profiled elements comprise machine bed supporting (6) means extending in a longitudinal direction and suitable for supporting a semi-worked piece to be worked in a working position, storing means (10, 12) suitable for delivering semi-worked pieces (4) to be worked and/or to receive already worked semi-worked pieces (14), moving means (58, 60, 62, 64, 66) arranged for moving said semi-worked pieces (4, 14) towards and/or away from said working position and movable in a plane transversal to said longitudinal direction immediately before delivering the semi-worked piece (4) to be worked in the working position and/or immediately after removing the already worked semi-worked piece (14) from the working position.

The invention relates to a machine and a method for working elongated elements, particularly metallic profiled elements, or profiled elements made of plastic or compound materials, used, for example, for manufacturing door or window frames, or structural elements in general.

Prior art comprises multi-spindles machine-tools, in which a profiled element to be worked is kept in a working position on a machine bed by means of plurality of fastening clamps which may be positioned in transversal sections arranged one next the other in a longitudinal direction on said machine bed. A plurality of operating units is slidably coupled in longitudinal direction on the machine bed, each one bearing tool means to carry out pre-established workings on a profiled element. At one end of the machine bed, a storage unit for profiled elements to be worked is arranged, which is shaped in such a way as to allow the profiled elements to be advanced one at a time to reach an insertion position on the machine bed in which the profiled element to be positioned on the machine bed is aligned with the clamps of the machine bed and can be positioned onto the machine bed, being axially pushed by means of a push-bar which pushes the rear end of the profiled element. At the other end of the machine bed, an extractor is arranged suitable for withdrawing a worked profiled element and longitudinally dragging the profiled element along the machine bed until the element is introduced into a storage unit for the worked profiled elements.

Therefore, both positioning and extracting of the profiled elements take place by sliding the profiled elements along sliding elements on the machine bed, which may cause damage to the profiled elements due to bumps between the profiled elements and said sliding elements, or due to the presence of shavings which may be accidentally interposed between the walls of the profiled element and the surfaces along which said profiled element has to slide to be brought in the working position, or extracted from the working position.

The risk of damaging the profiled element is particularly high if the profiled element has been superficially treated by painting, oxidation or similar treatments.

Furthermore, according to prior art, to carry out on a profiled element either cutting workings to divide a single semi-worked piece into portions, or workings on the side surfaces and on the end surfaces, or heads, of each portion, in general the profiled element has to be positioned on at least two different machines equipped for this purpose.

An object of the invention is to improve the known working systems for profiled elements.

A further object is to reduce the risk of damages to the profiled elements, particularly when they are positioned on the machine bed and/or extracted from said machine bed.

A still further object is to increase the productivity of the profiled element working systems.

In a first aspect of the present invention, an apparatus for working semi-worked pieces, in particular metallic profiled elements, is provided, comprising machine bed supporting means extending in a longitudinal direction and arranged for supporting a semi-worked piece to be worked in a working position, storing means arranged for delivering semi-worked pieces to be worked and/or receiving already worked semi-worked pieces, moving means arranged for moving said semi-worked pieces towards and/or away from said working position, characterized in that said moving means are characterized in that said moving means are movable in a plane transversal to said longitudinal direction immediately before delivering the semi-worked piece to be worked in the working position and/or immediately after removing the already worked semi-worked piece from the working position.

In a second aspect of the present invention, there is provided a method for working semi-worked pieces, in particular metallic profiled elements, comprising supporting a semi-worked piece to be worked extending substantially in a longitudinal direction in a working position, storing said semi-worked pieces to be worked and/or semi-worked pieces already worked, moving said semi-worked pieces towards and/or away from said working position, characterized in that said moving substantially comprises moving said semi-worked pieces transversally to said longitudinal direction for substantially preventing said semi-worked pieces from being moved along said longitudinal direction at least immediately before said semi-worked pieces reach said working position and/or at least immediately after said semi-worked pieces have been removed from said working position.

In this way, the risk of damage to the profiled element caused by grazing along the sliding surfaces of the machine bed, or parts thereof, is substantially prevented.

Furthermore, the productivity is also considerably increased, in particular when a plurality of profiled element portions axially and consecutively arranged along the machine bed are worked: in fact, after carrying out the working on one portion, said portion may be removed from the working position while the working of another portion has already begun.

In a third aspect of the present invention, there is provided a method for working semi-worked pieces, in particular metallic profiled elements, comprising supporting a semi-worked piece to be worked substantially extending in a longitudinal direction in a working position, cutting said semi-worked piece to separate from said semi-worked piece a portion of semi-worked piece separated from a remaining part of said semi-worked piece, obtaining a space between said portion and said remaining part, inserting an operating unit into said space to work ends of said portion and of said remaining part.

Advantageously, said obtaining comprises removing said remaining part from said portion.

Furthermore, since said portion is moved together with the clamps which hold it, the surface of the semi-worked piece is kept intact.

Owing to this aspect of the invention, it is possible to carry out workings on the ends of the portions of the profiled element, which previously could be performed only by positioning the portions on machines specially equipped for this purpose.

The invention will be better understood and carried out with reference to the description related to the attached drawings, which show an exemplifying and not restrictive embodiment thereof, in which;

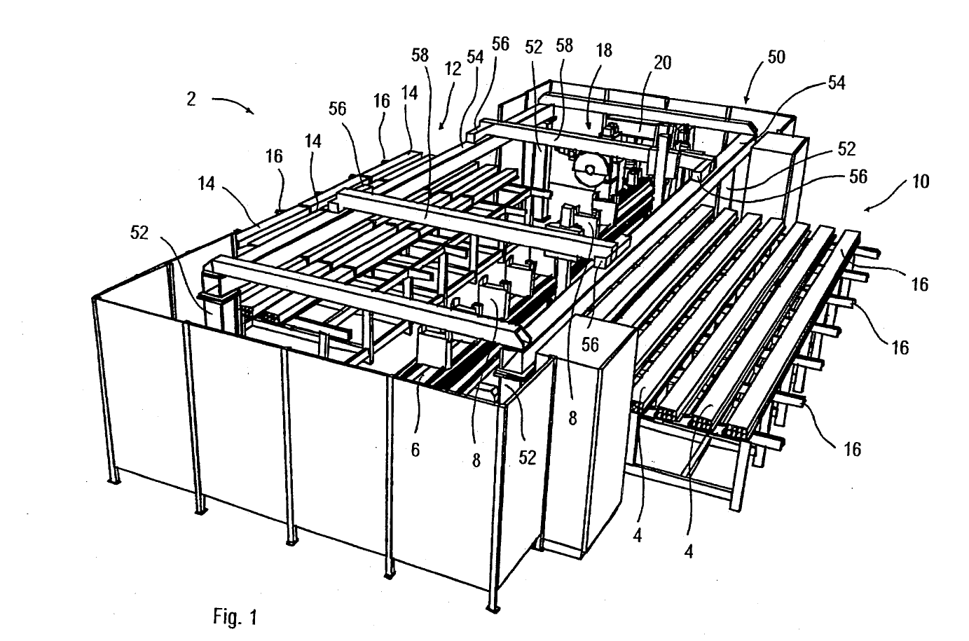

FIG. 1 is a perspective view of a machine tool according to the present invention as seen from one end of the machine bed;

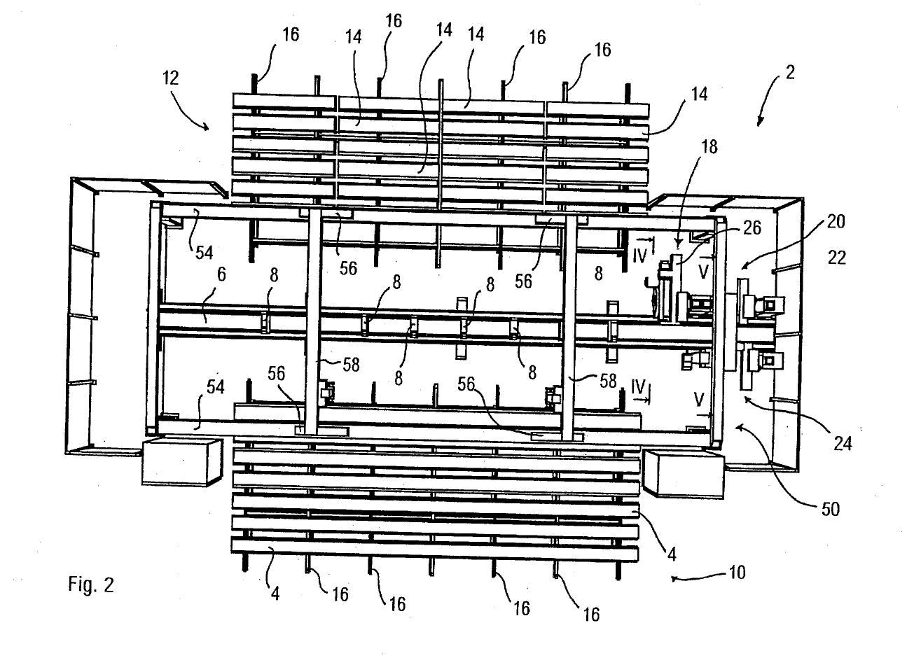

FIG. 2 is a top perspective view of the machine of FIG. 1;

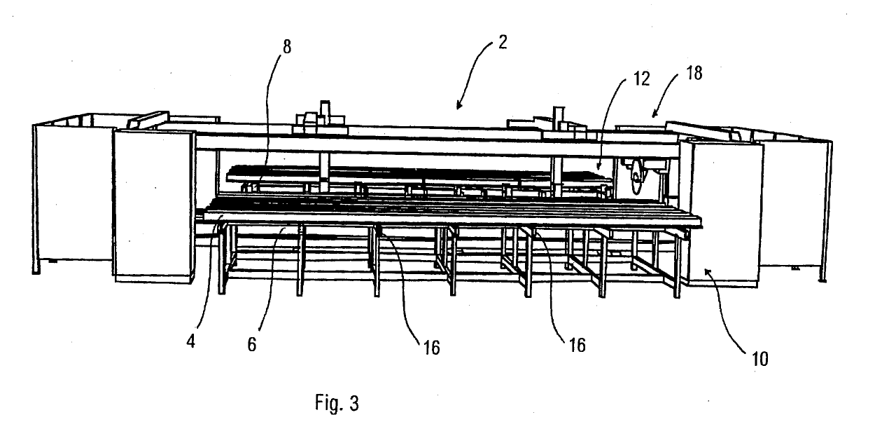

FIG. 3 is an elevation view of the machine of FIG. 1;

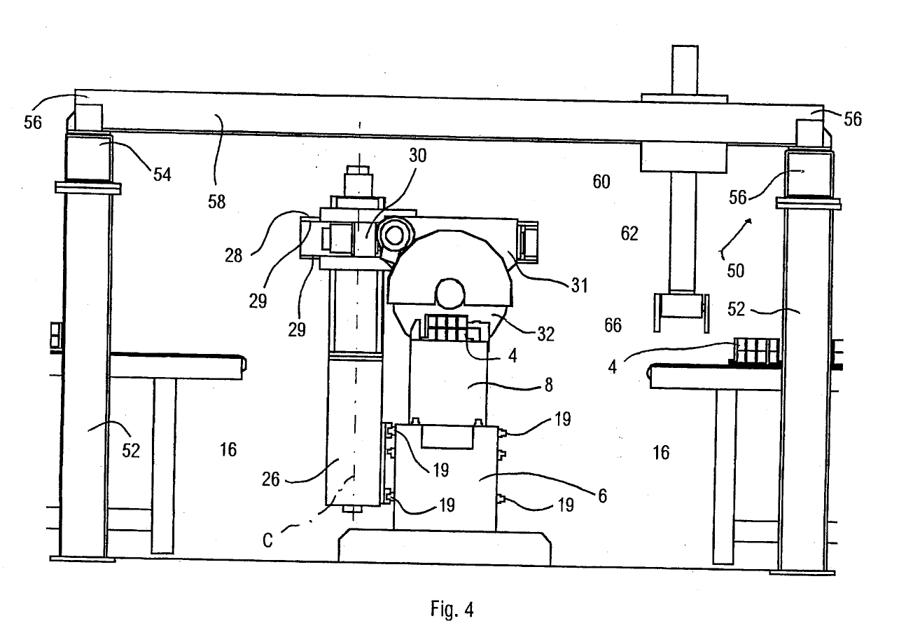

FIG. 4 is a section taken along plane IV-IV of FIG. 2;

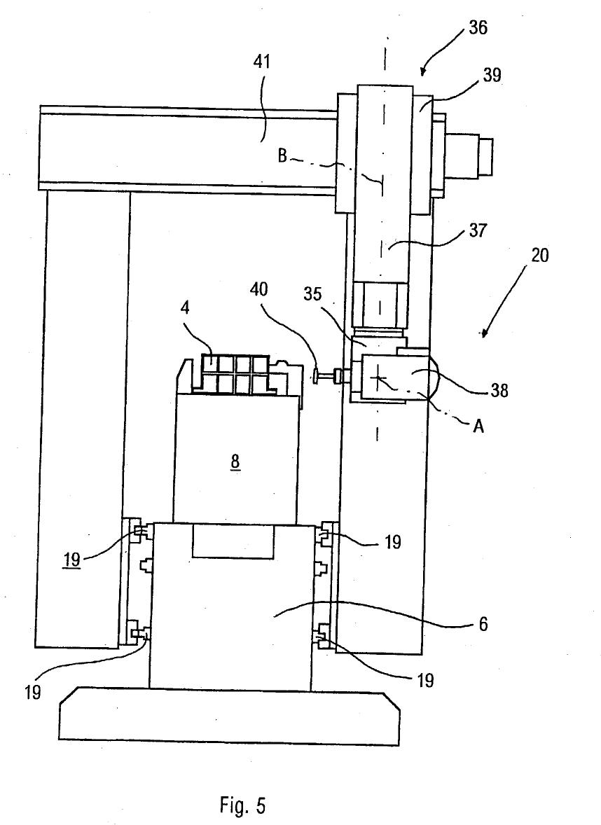

FIG. 5 is a section taken along plane V-V of FIG. 2;

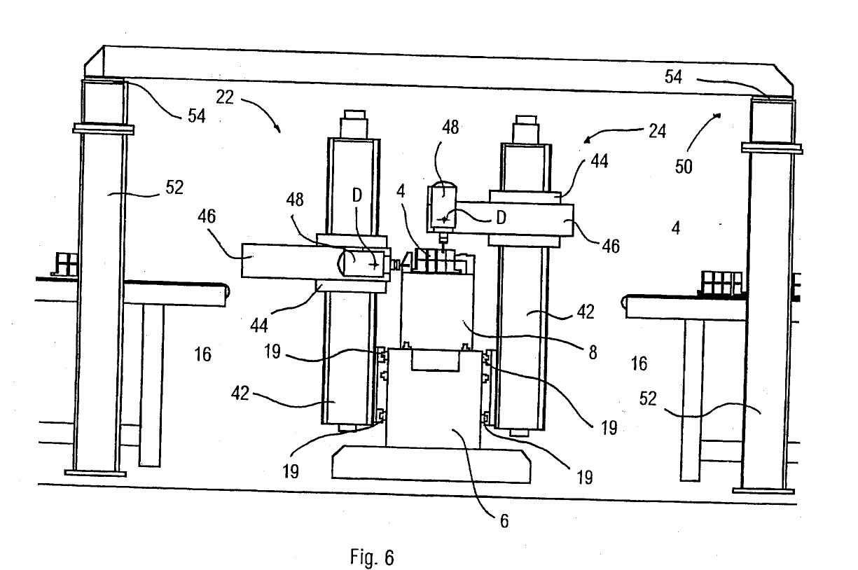

FIG. 6 is a section taken along the plane VI-VI of FIG. 2;

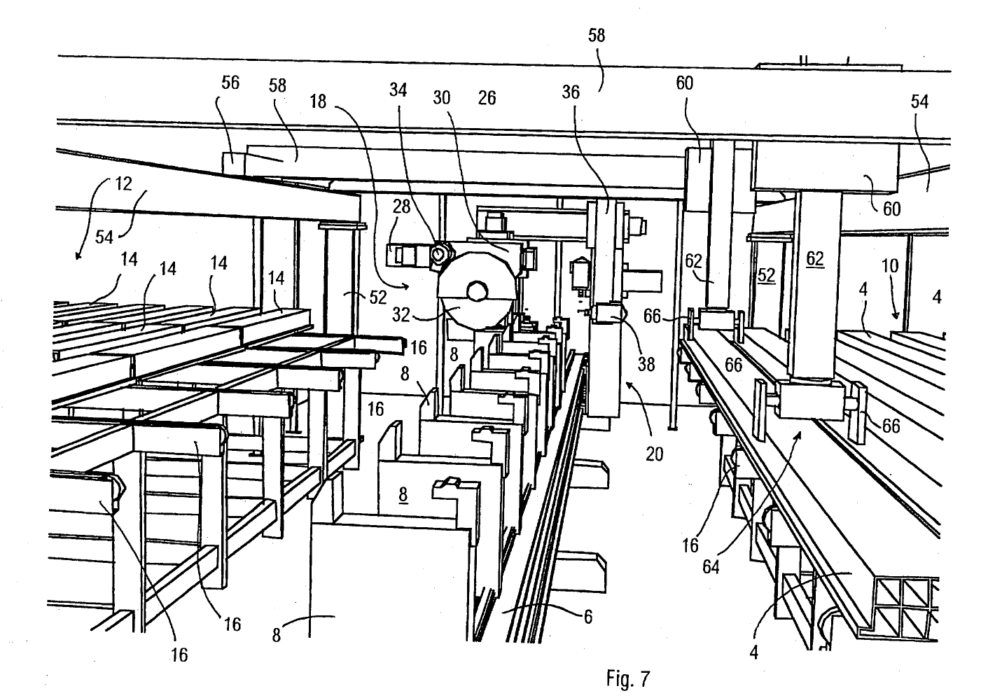

FIG. 7 is enlarged and broken perspective view, of the machine of FIG. 1, at the beginning of a work cycle;

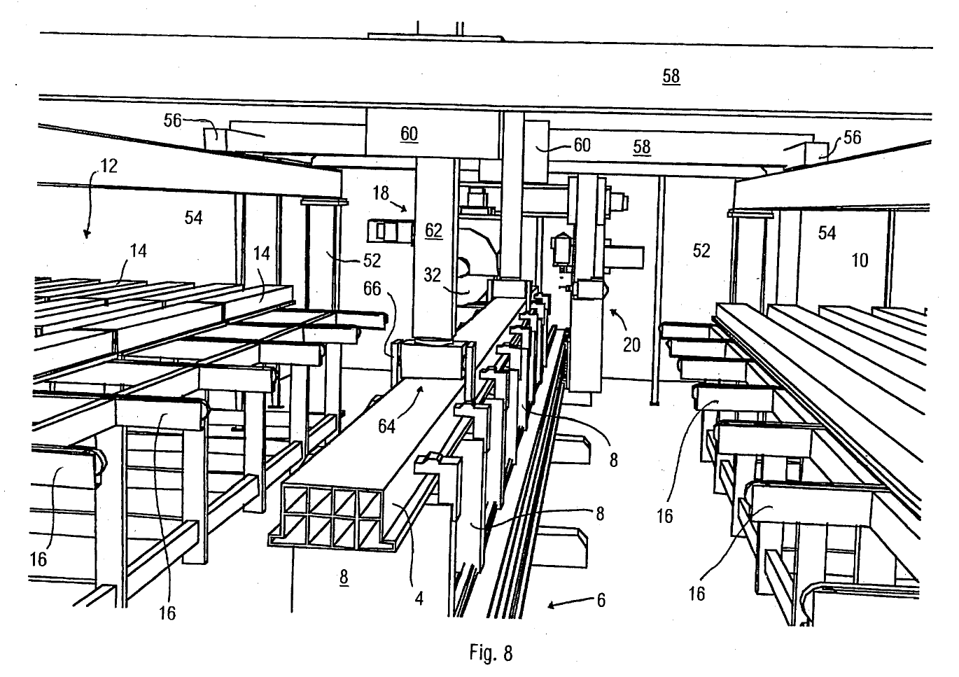

FIG. 8 is an enlarged and broken perspective view of the machine of FIG. 1, after a semi-worked piece has been positioned on the clamps of the machine bed, i.e. in the working position;

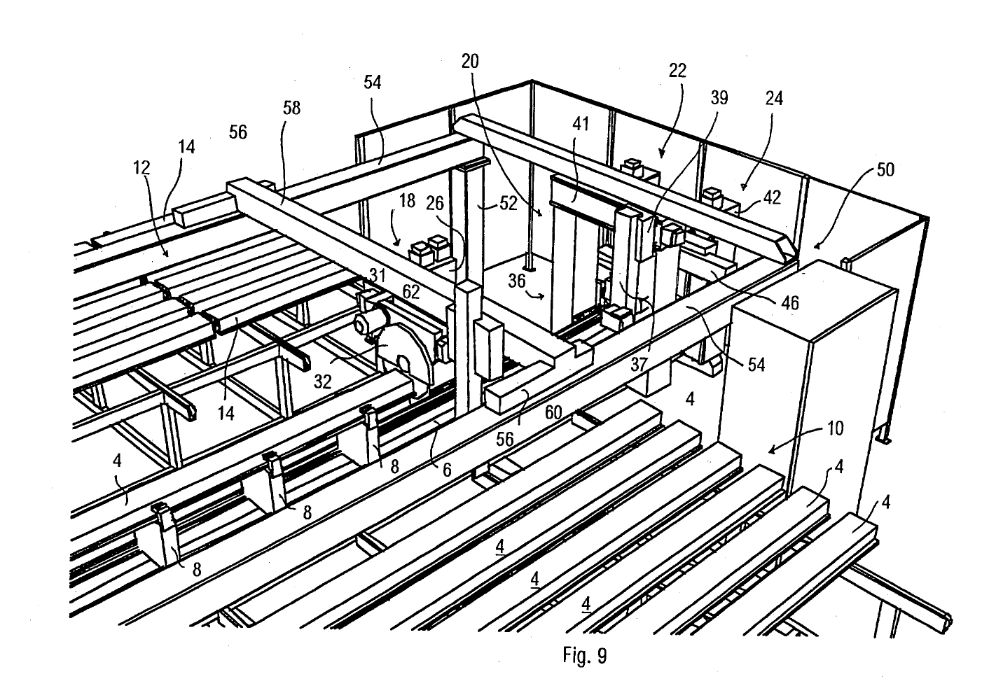

FIG. 9 is an enlarged and broken perspective view of the machine of FIG. 1, after the head of the semi-worked piece has been flattened;

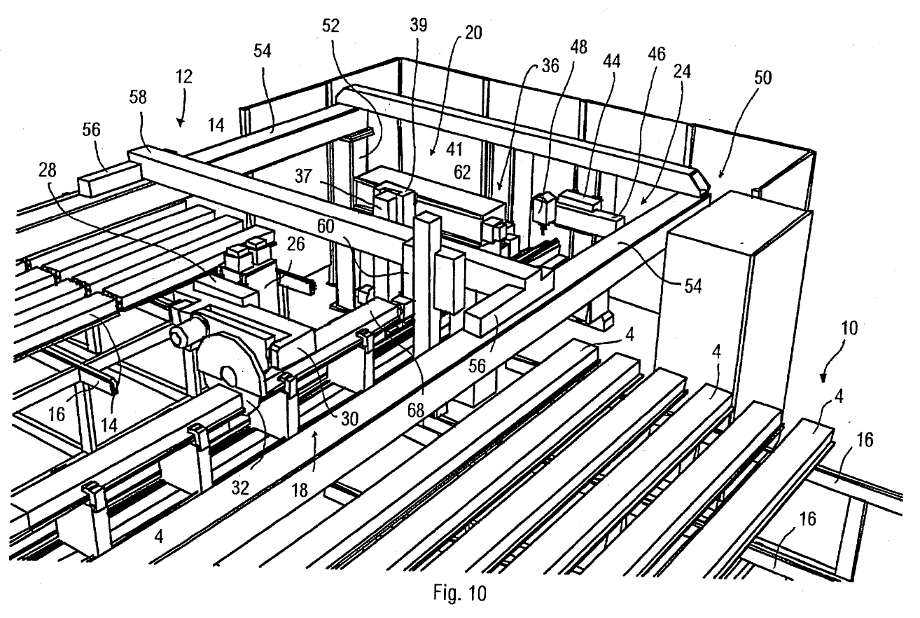

FIG. 10 is an enlarged and broken perspective view of the machine of FIG. 1, during cutting of the semi-worked piece to separate a portion from said semi-worked piece;

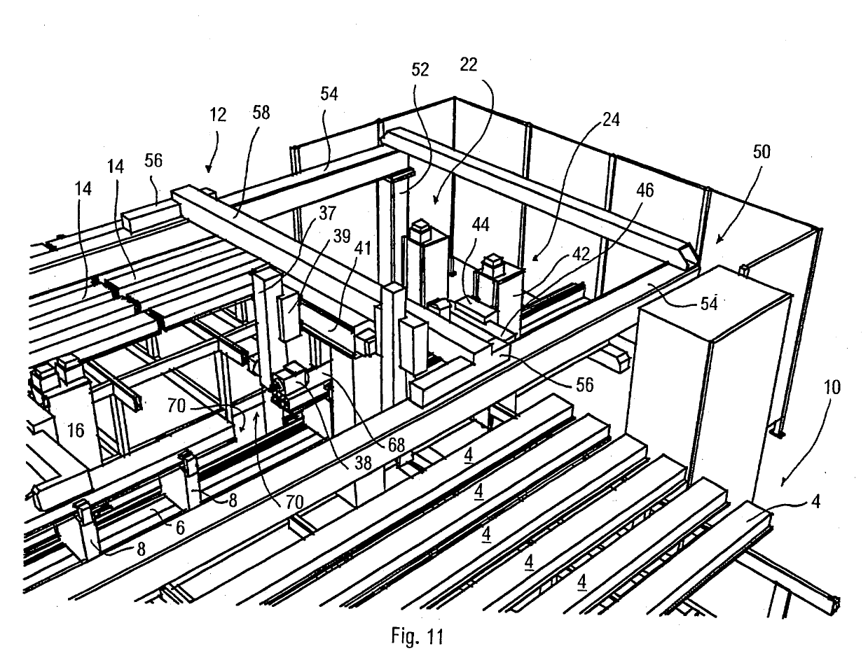

FIG. 11 is an enlarged and broken perspective view of the machine of FIG. 1, after a space has been obtained between the portion separated and the remaining part of profiled element;

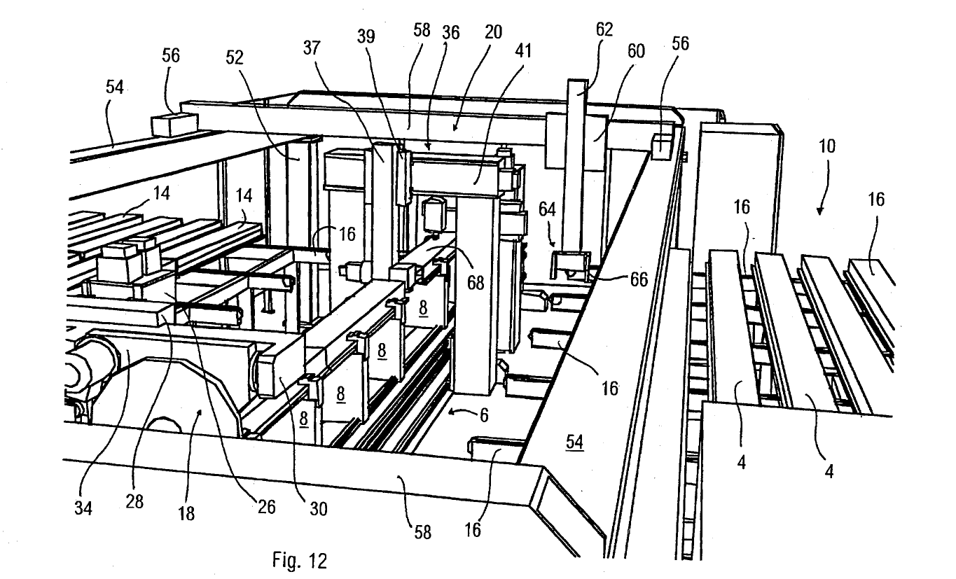

FIG. 12 is an enlarged and broken perspective view of the machine of FIG. 1, during working of the end of the remaining part of profiled element;

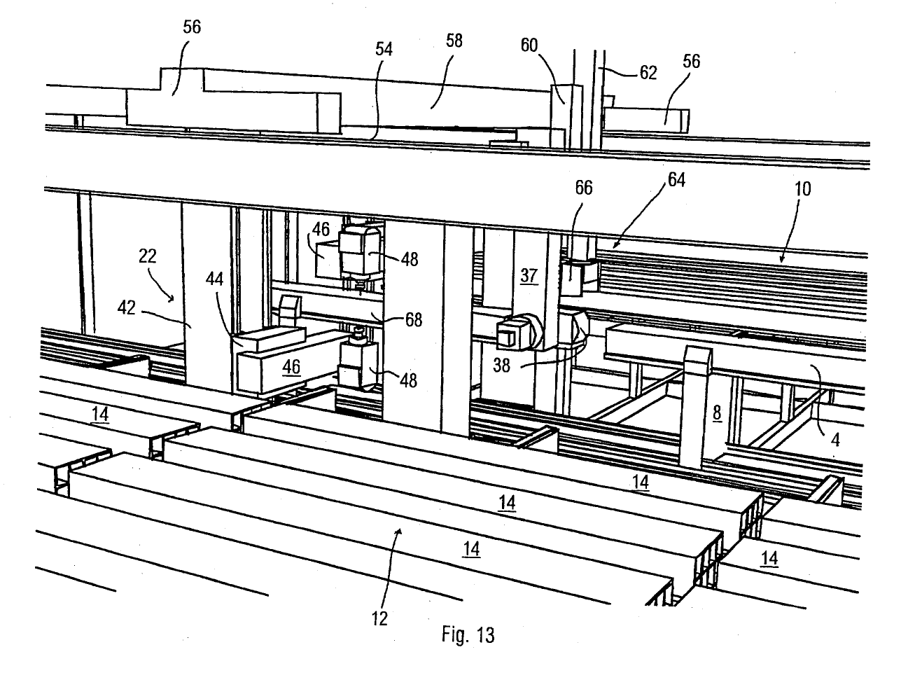

FIG. 13 is an enlarged and broken perspective view of the machine of FIG. 1, during working of the end of the portion of profiled element;

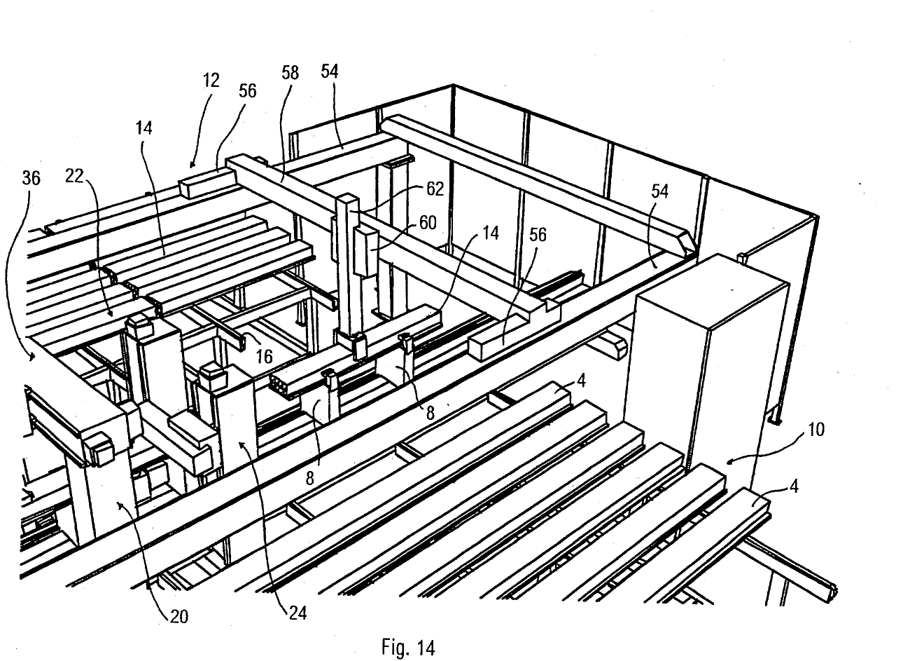

FIG. 14 is an enlarged and broken perspective view of the machine of FIG. 1, during removing of the worked portion from the working position;

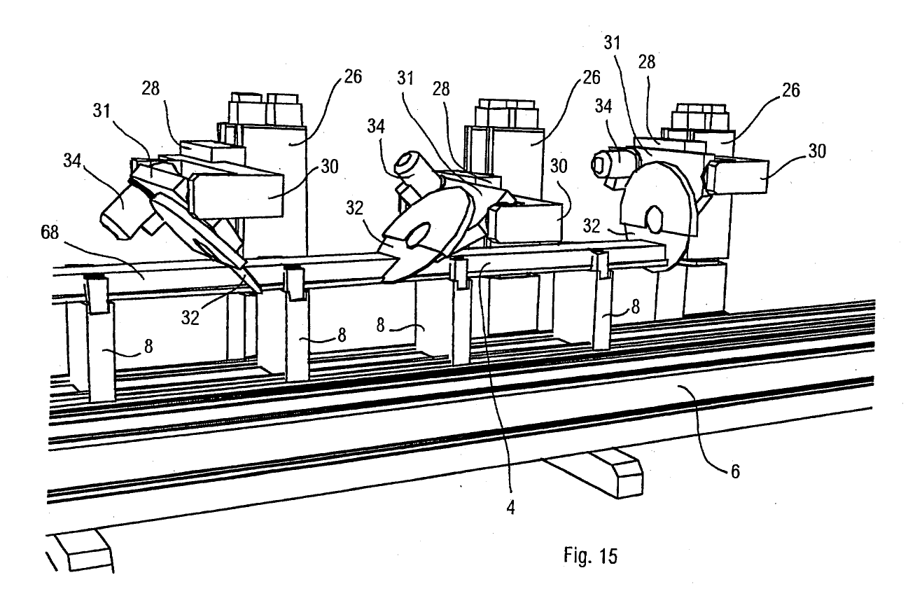

FIG. 15 is a broken perspective view of a section of the machine of FIG. 1 with a same cutting unit in three different operative positions;

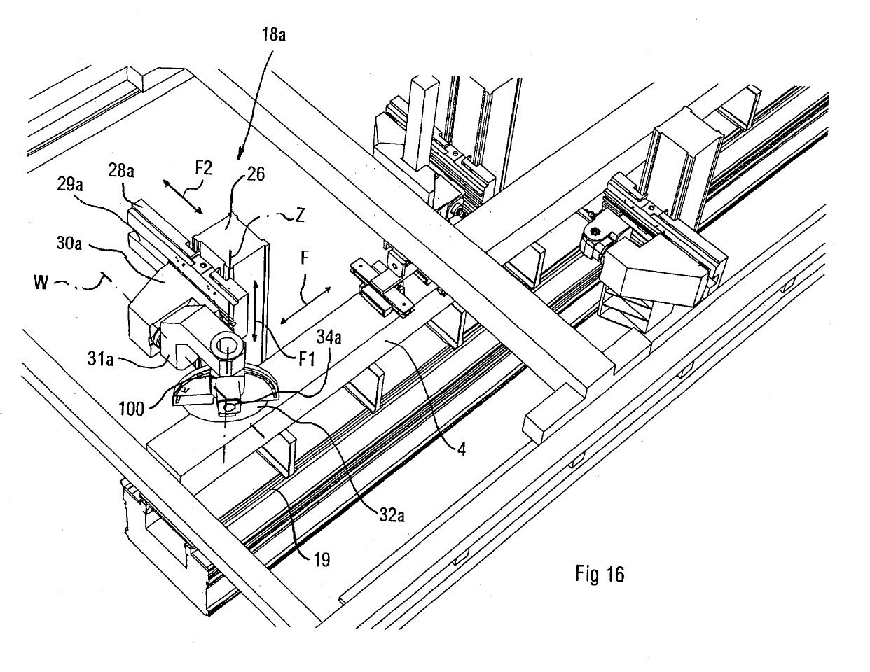

FIG. 16 is a broken top perspective view of a machine tool according to the present invention showing a variation of the cutting unit;

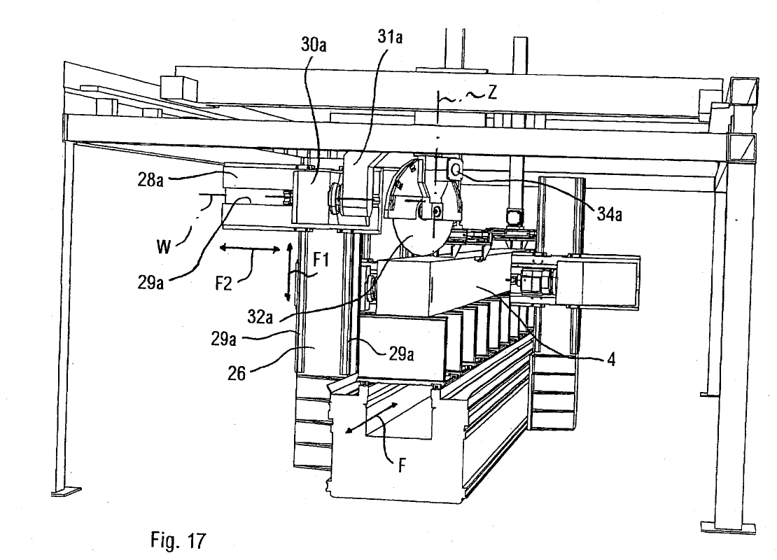

FIG. 17 is a broken front perspective view of the machine tool of FIG. 16.

As shown in FIGS. 1 to 6, a machine tool 2 for working metallic profiled elements 4 comprises a base 6 on which a plurality of clamps 8 may be longitudinally positioned by means of positioning means which arranges each clamp 8 in such a way that said clamp does not cover a part of the profiled element 4 to be worked which will be subjected to mechanical working processes.

A storage unit 10 for semi-worked pieces 4 to be worked and a storage unit 12 for portions 14 of already worked semi-worked pieces are arranged parallel to the machine bed 6 and at opposite sides thereof. Both storage units 10 and 12 comprise a plurality of parallel belt conveyors and are arranged transversal to the machine bed 6.

A cutting group 18, a first operating unit 20, a second operating unit 22 and a third operating unit 24 are slidably coupled in a longitudinal direction to the machine bed 6.

As shown in FIGS. 4 and 15, the cutting group 18 comprises an upright 26 rotatable around a vertical axis C and coupled at the bottom to longitudinal runners 19 of the machine bed 6, on the upright 26 being vertically movable a sliding block 28 to which a slide 30 horizontally slidable on sliding means 29 is slidably supported. A bar 31 rotatable around a horizontal axis is, hinged to the slide 30, said 31 carrying a circular blade 32 driven to rotate around a median axis thereof by means of a motor 34. Therefore, the blade 32 may keep pre-established angular positions transversal to the machine bed 6, so as to be able of carrying out oblique anyway oriented cuts on the semi-worked piece 4 to be worked.

With reference to FIGS. 16 and 17, a further cutting unit 18a is shown obtained according to a variation and comprising an upright 26a coupled at the bottom to longitudinal runners 19 of the machine bed 6 so as to slide on said machine bed 6 in the direction shown by the arrow F. On the upright 26a a further sliding block 28a is vertically movable, as shown by the arrow Fl. A further slide 30a is supported to said further sliding block 28a so as to be able to horizontally slide in the direction indicated by the arrow F2 on further sliding means 29a. A further bar 31a rotatable around a horizontal axis W is hinged to said further slide 30a to which a support element suitable for rotating around an axis Z perpendicular to the axis W is rotatably coupled. A further circular blade 32 driven to rotate around a median axis thereof by means of a relative motor 34a is coupled to said support element. In this way, the further blade 32 of the further cutting unit 18a is provided with an additional degree of freedom with respect to the blade 32 of the cutting unit 18, thus enabling the range of working processes which can be carried out on the profiled elements 4 to be further widened.

As shown in FIG. 5, the first operating unit 20 comprises a portal-like structure 36 crossing the machine bed 6, said portal-like structure 36 slides along the runners 19 and is provided with a spindle 38 carrying tool means 40 to carry out mechanical workings on the profiled element 4 to be worked or on parts thereof.

The spindle 38 is mounted on a support 35 so as to be angularly positionable around a horizontal axis A, the support 35 being mounted, so as to be angularly positionable around a vertical axis B, on a slide 37 vertically movable with respect to a trolley 39 sliding along a cross-bar body 41 of the portal-like structure 36. In this way, the tool means 40 may be so arranged as to easily work both the side surfaces of the semi-worked piece 4 being worked and the end surfaces—or ‘heads’—of the semi-worked piece 4 or parts thereof, except the surface facing the machine bed 6 which is difficult to work. As shown in FIG. 6, the second operating unit 22 and the third operating unit 24 have a symmetrical structure and are symmetrically arranged with respect to a longitudinal plane passing through the centre line of the machine bed 6.

Each of the operating units 22 and 24 comprises an upright body 42 slidably engaged to the runners 19, to which a vertically positionable slide body 44 is coupled; a respective arm 46 is coupled to said slide body 44 in such a way as to be able to slide horizontally in a transversal plane. Each respective arm 46 has an end near the machine bed 6 supporting a spindle unit 48 which may be angularly positioned with respect to a horizontal axis D.

Above the machine bed 6, the cutting unit 18 and the operating units 20, 22 and 24 a frame 50 supported by columns 52 is arranged, said frame 50 being provided with guiding tracks 54 extending parallelly to the machine bed 6 and on which the ends 56 of a pair of bridge structures 58 are longitudinally slidable, each of said bridge structures 58 supporting a trolley 60 longitudinally slidable along the guide tracks 54; to each trolley 60 a vertically movable rod 62 is coupled, the lower end thereof supporting respective pliers 64 having jaws 66 suitable for clamping the profiled element 4 to be worked, or the already worked portions 14.

The bridge structures 58 and the pliers 64 coupled thereto may be positioned on the profiled elements 4, remove the profiled elements 4 from the storage unit 10 for the semi-worked pieces to be worked and place the profiled elements 4 one at a time on the clamps 8, which lock them in a working position. When a profiled element 4, or a portion thereof, has been worked, the pliers 64 remove the profiled element from the working position and transfer it in the storage unit 12 for the already worked semi-worked pieces.

The machine works according to the operative sequence shown in FIGS. 7 to 14, and more precisely: with reference to FIG. 7, the pliers 64 withdraw from the storage unit 10 for semi-worked pieces to be worked a profiled element 4 resting on the belts 16 and transfer the profiled element 4 to the working position onto the clamps 8 of the machine bed 6 which have been previously suitably so positioned as not to interfere with the working of the profiled element 4; the semi-worked piece 4 is lifted from the belts 16 and positioned on the clamps 8 by being lowered until it rests on the clamps 8: in this way the risk of the profiled element 4 being scratched, or damaged while being transported in the working position is prevented. Subsequently, (FIG. 8), the clamps 8 are closed to lock the profiled element 4 in the working position and, while the pliers 64 are still holding the profiled element 4, the bridge structures 58 are translated in a longitudinal direction, dragging the clamps 8 and the profiled element 4 locked thereby on the machine bed 6 to an operative position for the beginning of the working cycle; it has to be noted that the profiled elements 4 are transferred without sliding on the clamps. Alternatively, the clamps 8 and the profiled element locked thereby may be longitudinally moved by means of another suitable actuator, such as for example, the cutting unit 18, or the operating units 20, 22 and 24.

After the profiled element 4 has been brought to the working position corresponding to the beginning of the working cycle, as shown in FIG. 9, the cutting unit 18 is caused to slide, by means of suitable driving means, on the machine bed 6 and the circular blade 32 is moved along a transversal plane to carry out flattening of the profiled element 4. Subsequently, the cutting unit 18 is moved to a section of the profiled element 4 in which a further transversal cut has to be carried out for separating a portion 68 of profiled element to be worked from the profiled element 4. The portion 68, still held by the clamps, is moved along the machine bed 6 in a direction opposite to the direction along which the profiled element 4 had been moved to reach the working position for the beginning of the work cycle. The portion 68 is moved by means of a suitable actuator, such as, for example, the first operating unit 20, to obtain a space between the portion 68 and the remaining part of the profiled element 4.

In the meantime, the cutting unit 18 is moved to another section of the profiled element 4 in which another transversal cut has to be made, as shown in FIG. 10.

As shown in FIG. 11, the portion 68 and the remaining part of the profiled element 4 facing said portion 68 are worked by means of the first operating unit 20, which may, for example, carry out flattening of the end surfaces 70; furthermore, at the same time, the operating units 22 and 24 may work the side surfaces of the portion 68, including the surface facing the machine bed 6, to obtain a completely worked profiled element 14, as shown in FIGS. 12 and 13.

The worked profiled element 14, after being released from the clamps 8, is then removed from the working position by the pliers 64, which lift the profiled element 4 from the clamps 8 to prevent it from grazing the clamps, and transferred into the storage unit 12 for the worked profiled elements.

It is to be intended that the units, the devices and the parts mentioned in the preceding description, as well as in the respective combinations indicated, may also be object of separate protection for which divisional applications may be filed.

1. Apparatus for working semi-worked pieces, in particular metallic profiled elements, comprising machine bed supporting means (6) extending in a longitudinal direction and arranged for supporting a semi-worked piece to be worked in a working position, storing means (10, 12) arranged for delivering semi-worked pieces (4) to be worked and/or to receive already worked semi-worked pieces (14), moving means (58, 60, 62, 64, 66) arranged for moving said semi-worked pieces (4, 14) towards and/or away from said working position, characterized in that said moving means (58, 60, 62, 64, 66) are movable in a plane transversal to said longitudinal direction immediately before delivering the semi-worked piece (4) to be worked in the working position and/or immediately after removing the already worked semi-worked piece (14) from the working position.

2. Apparatus according to claim 1, wherein said moving means (58, 60, 62, 64, 66) extends substantially above said machine bed means (6).

3. Apparatus according to claim 1, or 2, wherein said moving means (58, 60, 62, 64, 66) comprises bridge means (58) slidably supported in a longitudinal direction along guiding tracks (54) parallel to and arranged above said machine bed means (6).

4. Apparatus according to claim 3, wherein said bridge means (58) supports pliers means (64, 66) via trolley means (60) slidably coupled to said bridge means (58).

5. Apparatus according to claim 3, or 4, wherein said pliers means (64, 66) may be vertically moved with respect to said bridge means (58).

6. Apparatus according to any one of the preceding claims, wherein said storing means (10, 12) are arranged parallelly to said machine bed means (6) and extends on one side of said machine bed means (6).

7. Apparatus according to claim 6, wherein said storing means (10, 12) comprises storage means (10) for semi-worked pieces to be worked and storage means (12) for already worked semi-worked pieces.

8. Apparatus according to any one of the preceding claims, and further comprising a cutting unit (18, 18a) supported on runners (19) of said machine bed means (6) so as to be longitudinally positionable with respect to said machine bed means (6), said cutting unit (18; 18a) being arranged for cutting said semi-worked piece (4) along a transversal plane.

9. Apparatus according to any one of the preceding claims, and further comprising at least one operating unit (20, 22, 24) supported on runners (19) of said machine bed means (6) so as to be longitudinally positionable with respect to said machine bed means (6), said at least one operating unit (20, 22, 24) being arranged for carrying out workings on surfaces of said semi-worked piece (4).

10. Apparatus according to claims 8 or 9, wherein said at least one operating unit (20, 22, 24) is arranged between said cutting unit (18; 18a) and the end of said machine bed means (6).

11. Method for working semi-worked pieces, in particular metallic profiled element, comprising supporting a semi-worked piece (4) to be worked extending substantially in a longitudinal direction in a working position, storing said semi-worked pieces (4) to be worked and/or already worked semi-worked pieces (14), moving said semi-worked pieces (4, 14) towards and/or away from said working position, characterized in that said moving substantially comprises moving said semi-worked pieces (4, 14) transversally to said longitudinal direction for substantially preventing said semi-worked pieces (4, 14) from being moved along said longitudinal direction at least immediately before said semi-worked pieces reach said working position and/or at least immediately after said semi-worked pieces have been removed from said working position.

12. Method according to claim 11, wherein said moving takes place above said machine bed means (6).

13. Method according to claim 11, or 12, wherein said moving comprises moving said profiled elements (4, 14) in a vertical plane.

14. Method according to any one of claims 11 to 13, wherein said storing comprises placing said semi-worked pieces (4, 14) parallel to said machine bed means (6) on a side thereof.

15. Method according to claim 14, wherein said storing comprises placing said semi-worked pieces (4) to be worked and said already worked semi-worked pieces (14).

16. Method according to any one of claims 11 to 15, and further comprising cutting said semi-worked piece (4) to separate from said semi-worked piece a portion (68) of semi-worked piece separated from the remaining part of said semi-worked piece (4) and obtaining a space between said portion and said remaining part.

17. Method according to claim 16, wherein said obtaining comprises moving said portion (68) away from said remaining part of semi-worked piece (4) in a longitudinal direction.

18. Method according to claim 16, or 17, wherein, after said obtaining, inserting at least one operating unit (20, 22, 24) into said space is provided, so that it is possible to work ends of said portion (68) and of said remaining part of said semi-worked piece (4) to be worked.

19. Method for working semi-worked pieces, in particular metallic profiled elements, comprising supporting a semi-worked piece (4) to be worked extending substantially in a longitudinal direction in a working position, cutting said semi-worked piece to separate from said semi-worked piece a portion (68) of semi-worked piece separated from a remaining part of said semi-worked piece (4), obtaining a space between said portion and said remaining part, inserting at least an operating unit (20, 22, 24) into said space to work ends of said portion (68) and of said remaining part.

20. Method according to claim 19, wherein said obtaining comprises moving said portion (68) away from the remaining part of semi-worked piece (4) in a longitudinal direction.

21. Method according to claim 19, or 20, and further comprising storing semi-worked pieces to be worked (4) and/or already worked semi-worked pieces (14) arranging said semi worked pieces (4, 14) parallel to said machine bed means (6) on a side thereof.

22. Method according to any one of claims 19 to 21, and further comprising moving said semi-worked pieces (4, 14) towards and/or away from said working position, transversally to said longitudinal direction for substantially preventing said semi-worked pieces (4, 14) from being moved along said longitudinal direction at least immediately before said semi-worked pieces reach said working position and/or at least immediately after said semi-worked pieces have been removed from said working position.

23. Method according to claim 22, wherein said moving takes place above said machine bed means (6).

24. Method according to claim 22, or 23, wherein said moving comprises moving said profiled elements (4, 14) in a vertical plane.
